(19) United States
(12) Patent Application Publication
(10) Pub. No.: US 2013/0273906 A1
(43) Pub. Date: Oct. 17, 2013

(54) METHOD FOR THE REDUCTION OF ENERGY COMSUMPTION AND RADIO INTERFERENCE IN A RADIO ACCESS NODE

(71) Applicants: Luis Cucala Garcia, Madrid (ES); Carlos Gandarillas Diego, Madrid (ES); Pilar Ruiz Aragon, Madrid (ES)

(72) Inventors: Luis Cucala Garcia, Madrid (ES); Carlos Gandarillas Diego, Madrid (ES); Pilar Ruiz Aragon, Madrid (ES)

(73) Assignee: TELEFONICA, S.A., Madrid (ES)

(21) Appl. No.: 13/991,337

(22) PCT Filed: Dec. 1, 2011
(86) PCT No.: PCT/EP11/71580

§ 371 Date: Jun. 25, 2013

(30) Foreign Application Priority Data
Dec. 10, 2010 (ES) P201031815

(51) Int. Cl. H04W 52/02

(52) U.S. Cl. CPC H04W 52/0206
USPC 455/426.1

(57) ABSTRACT

It comprises switching on or switching off at least part of said radio access node, such as a femtonode functionality radio section and/or other radio sections, as a function of, respectively, the reception by said radio access node, of a radio signal transmitted by a wireless portable processing device, or the absence of such a reception, where said radio signal is a low-power radio signal transmitted by a low-power radio interface of said wireless portable processing device.

### FIELD OF THE ART

The present invention generally relates to a method for the reduction of energy consumption and radio interference in a radio access node, and more particularly to a method comprising switching on or switching off radio sections of the radio access node as a function of the reception or absence of reception of low-power radio signals.

The invention is particularly devised for the provision of network communication capabilities in an indoor environment, and in particular in homes and small offices.

### PRIOR STATE OF THE ART

For the provision of said network communication capabilities, the current technology relies on ADSL routers, which include the access functionality to the telecom operator network, and wired (e.g. Ethernet [1] supported on UTP cable) and wireless (e.g. Wi-Fi IEEE 802.11 [2]) indoors connectivity.

Other existing technology for this application is based on the deployment of a fibre for the access of the home to the operator's network (FTTH), usually implementing a GPON type network. In this case, the networking device installed at the customer's premises is an ONT [3]. The ONT provides connectivity to the access network, and indoor wired connectivity by means of Ethernet interfaces and UTP cables. In this case, if wired connectivity is required, an external Wi-Fi router is usually connected to one of the ONT Ethernet ports.

Other existing solution for the provision of indoor connectivity is a hybrid wireless gateway, an equipment that integrates a mobile wireless access modem (e.g. an HSPA modem), and wired Ethernet connectivity and wireless Wi-Fi for indoors.

Another solution that is being deployed for the provision of indoor wireless connectivity is the femtonode or femtocell, called Home Node B or Home eNode B in 3GPP specifications [4]. A femtonode is a simplified Base Station that provides mobile wireless coverage within the customer's premises, and that is connected to the telecom operator's core network through the copper or fibre access network.

On the other hand, Telefonica has filed spanish patent applications P200800878 and P200802049 describing a “Radio Access Node”, a multi-radio and multi-interface equipment for the provision of access functionalities and indoors networking capabilities, based on a modular design where simple plug-in modules are inserted in a Base Unit in order to add new communication interfaces, implementing Software Defined Radio technology to update the plug-ins to new versions of the communication interfaces. In this context, a femtonode can be considered a simplified version of a Radio Access Node.

Telefonica has also filed patent application P200930549, describing a particular implementation of the “Radio Access Node”, where a multiplex of DVB-T multimedia contents are received from a fibre-based access network at the “Radio Access Node”, and the “Radio Access Node” wirelessly transmits a subset of this multiplex by means of a modified DVB-T radio interface operating in the ISM 5 GHz band.

### Problems with Existing Solutions

Any technical implementation for the provision or indoor wireless connectivity must cope with the radio interference generated from other radio devices in the neighbouring area. A radio interference is any unwanted radio signal that overlaps with the desired signal and reduces its Signal to Interference and Noise Ratio (SINR), thus degrading the total throughput that can be achieved.

Some wireless indoor communications radio interfaces implement techniques to cope with radio interference. For example, Wi-Fi IEEE 802.11n implements a Dynamic Frequency Selection technique in order to select unoccupied channels. Other examples are the Radio Resource Management scheduler algorithms that can be applied in Long Term Evolution (LTE) femtonodes [5], that assign to every User Equipment the best radio resources at every moment, taking into account propagation conditions and interference level.

In general these are reactive methods, as they try to cope with the existing interference but do not implement any method to actually reduce it. The best method, as it is described in this patent application, is a preventive one that seeks to reduce the unwanted radio emissions when they can be avoided. This can be done if the interferer radios are switched off when they are not necessary, in particular when the customer is not at home.

The best preventive radio interference method, as it is proposed in this invention, is to switch on the femtonode, or any radio interface that could be supported by a Radio Access Node, only when the user is within his/her premises (home, office), and there is currently no solution that implements this method.

On the other hand, when the femtonode or any other radio section is radiating when the customer is not nearby, it also results in an unnecessary power consumption, which could be reduced if some switching off method were implemented.

Some implementations have been proposed for switching off the radio section of a femtonode when the user is not in the neighbourhood of his/her femtonode [6] [7]; these solutions detect when the user Equipment is camped in the nearest macro cell to the femtonode, in order to decide when switching on or off the femtonode. When the User Equipment is not camped in a predefined macrocell it is assumed to be far away from home and the femtonode is switched off, and when the User Equipment enters in its predefined macrocell, it is assumed to be in the neighbourhood of its corresponding femtonode, which is switched on. But these implementations are of little value when the User Equipment is usually camped in the predefined macrocell, something very usual in suburban and rural macrocells that provide a wide coverage, or that can happen in dense urban areas depending on the customer habits or usage scenario.

Other existing implementation [8] switches off the transceiver section of the femtonode when it is not supporting any active connection with an User Equipment. In order to switch on the femtonode when it must support an active connection, that implementation relies on the help of the closest serving macrocell; that serving macrocell detects when an User Equipment which is included in the Closed Subscriber Group of the femtocell attempts to establish an active connection with the macrocell, and in that case it sends an indication to the femtonode to switch on, through the Mobility Management Entity and the so-called S1 interface, and then handovers the active connection to the femtocell. The problem with this solution is that in the case the User Equipment belongs to many Closed Subscriber Groups within the coverage area of the macrocell, the macrocell will not have any way to know which femtocell must be switched on. Another problem is that the User Equipment may establish an active connection with the macrocell when it is not within the potential coverage area of the femtocell, and thus that solution will switch on the femtocell unnecessarily. Another problem is that the implementation requires a high signalling traffic through the S1 interface and loads the Mobility Management Entity.

Other implementation [9] relies on an activation server, which remotely switches on or off the transceiver section of the femtonode. The criteria for the activation server to switch on or off the transceiver section of the femtonode is the location of the User Terminal, which is known to the activation server through GPS data reported by the User terminal, or deduced from the macrocell where the User Equipment is camping. The problem with this solution is that in many occasions the User Terminal will not include a GPS receiver, and that some communication method will have to be implemented to convey the GPS data up to the activation server. In the case that the location information is based on the camping macrocell, the same problems as stated for [6] and [7] can be applied.

Other proposed implementation [10] for switching on or off a base station is based on the traffic load of a set of base stations, switching off some of them when the total traffic load is low enough. This implementation does not tackle the specific case of switching on or off a femtonode when the user is or is not within the coverage of the femtocell, as the criteria for switching is the total load of the surrounding macrocells. On the other hand, this implementation cannot work properly in those scenarios when only a set of specific User Terminals are allowed to camp in a femtocell.

Other implementation [11] for switching on or off a femtonode is based in the detection of specific signal patterns transmitted by the User Equipment, which requires that a femtonode whose transceiver is switched off periodically switches on the receiver section in order to be able to detect the User Equipment signal pattern. The implementation makes also possible to switch on the transceiver section of the femtonode when a trigger signal is received through the S1 interface, in order to make possible for the User Equipment to receive incoming calls when the femtonode is switched off. This implementation requires that the User Equipment sends a specific signal pattern in a regular way, which increases its power consumption and battery drainage, and which increases the radio resources used for signalling purposes, and the implementation requires that the femtonode periodically activates the receiver, which also increases its power consumption. This implementation has also a severe impact on the handover methods, because the User Equipment will be neither registered in the femtocell nor the User Equipment will have the femtocell registered in its neighbour cell list.

On the other hand, document [12] is a 3GPP working document where implementations from [6] to [11] are proposed as possible solutions for the femtonode switching, but it does not provide any further advance with respect to the implementations described in those patent applications. Document [12] mentions the possibility of using a specific radio interface like Bluetooth to determine when the User Equipment is close to the femtonode, but it does not tackle the problem of a specific implementation that makes possible to reduce as much as possible the power consumption derived from such radio interface, as it is described in this invention.

### DESCRIPTION OF THE INVENTION

It is necessary to offer an alternative to the state of the art, which covers the gaps found therein, by providing a method which implementation really reduces the energy consumption and radio interference of a radio access node, in a high degree when compared to the conventional methods cited in the above section.

To that end, the present invention relates to a method for the reduction of energy consumption and radio interference in a radio access node, comprising switching on or switching off at least part of said radio access node as a function of, respectively, the reception by said radio access node, of a radio signal transmitted by a wireless portable processing device (such as a mobile phone, a PDA, or any other portable user equipment), or the absence of such a reception.

On contrary to the closest prior art, i.e. to the proposal of [11], cited in [12] as Scenario 4, where said radio signal is of a specific signal pattern, the radio signal used according to the method of the invention is a low-power radio signal transmitted by a low-power radio interface of said wireless portable processing device.

For an embodiment of the method of the invention said part of said radio access node to switch on or off comprises at least one femtonode functionality radio section and/or at least one other radio section of another kind, and, optionally, also other functional units.

According to an embodiment of the method of the invention said reception of said low-power radio signal by the radio access node is performed by means of a detection radio interface, the wireless portable processing device also comprising a detection radio interface, the method comprising using said detection radio interfaces to establish a short range radio link there between, said low-power radio signal being responsible, at least in part, for said short range radio link establishment.

As per a preferred embodiment, said switching on or switching off at least part of said radio access node is carried out also as a function of, respectively, detecting the establishment/presence or breaking/absence of said short range radio link.

For some embodiments, said low-power radio interface is one of a low energy Bluetooth interface, a low power Ultra Wideband interface and a low power Zigbee interface, although the invention is not limited to any specific kind of low-power radio interface.

As for the detection radio interfaces is concerned, these are, for different embodiments, one of Basic Rate/Enhanced Data Rate Bluetooth IEEE 802.15.1 radio interfaces, Bluetooth Low Energy IEEE 802.15.1 radio interfaces, Bluetooth Low Energy IEEE 802.15.1 radio interfaces that make use of the proximity profile for mobile phones in order to perform automatic actions, Ultra-Wideband IEEE 802.15.4a radio interfaces, Zigbee PRO Feature Sets, other solution based on IEEE 802.15.4-2006 radio interfaces and other short range radio interfaces.

The method comprises, for an embodiment, carrying out said switching on by performing the next steps:
setting a detection radio interface of the radio access node to a default Advertising state, where advertising packets are emitted, while its femtonode functionality radio section and/or any other radio section is in its default off state;
setting the detection radio interface of the wireless portable processing device to an Initiating default state at which the wireless portable processing device is searching for advertising radio packets emitted from any radio access node detection radio interface included in an accessible radio access nodes list; and:
   if as a result of said searching advertising packets are detected at the wireless portable processing device, checking, by the latter, if the radio access node detection radio interface identification, or DRI-ID, included in the detected advertising packets is included in its accessible radio access nodes list, and if so changing the detection radio interfaces of both the wireless portable processing device and the radio access node to a Connect status where said short range radio link is established.

If the detection radio interfaces of the wireless portable processing device and the radio access node lose the Connect state, said short range radio link being broken, the method comprises making them to return to their respective Initiating and Advertising status, and the Radio Access Node femtonode functionality radio section and/or any other radio section switches off.

For an embodiment, if as a result of said searching for advertising radio packets the wireless portable processing device detection radio interface does not detect any advertising packet from some radio access node included in said accessible radio access nodes list, the method comprises keeping it in the Initiating state.

For an alternative embodiment, if as a result of said searching for advertising radio packets the wireless portable processing device detection radio interface does not detect any advertising packet from some radio access node included in said accessible radio access nodes list, the method comprises checking, for a predetermined time, by means of the wireless portable processing device, if the wireless portable processing device is camping in some of the macrocells included in a Femto Overlapping Macrocells list, and:
if it is not camping in any of said macrocells, the method comprises determining by the wireless portable processing device that the latter is not either in the neighbourhood of its femtonode or camped in it, then switching its detection radio interface to Stand by status and communicating with the radio access node to make it switch its detection radio interface to Stand by status;
if it is camping in any of said macrocells, the method comprises determining by the wireless portable processing device that the latter is in the neighbourhood of its femtonode but not camped in it, then switching its detection radio interface to Initiating state and communicating with the radio access node to make it switch its detection radio interface to Advertising state;

The method also comprises, for an embodiment, updating a Femto Overlapping Macrocells list stored at said radio access node immediately after switching off its femtonode radio transmitter section and before switching off its femtonode radio receiver section.

Once said short range radio link has been established and the femtonode functionality radio section and/or any other radio section is switched on, the method comprises, for an embodiment, checking, for a predetermined time, by means of the wireless portable processing device and the radio access node, if the wireless portable processing device is camping in the radio access node femtonode functionality, and if so switching the detection radio interfaces of the wireless portable processing device and the radio access node to a Stand by state.

If after lapsing said predetermined time said wireless portable processing device is not camping in the radio access node femtonode functionality, the method comprises two possible developments of said embodiment, or groups of actions to be done.

For a first development, the method comprises switching the detection radio interface of the wireless portable processing device to its Initiating state, the detection radio interface of the radio access node to its Advertising state, and switching off the femtonode functionality radio section and/or any other radio section.

For a second development, the method comprises checking if the detection radio interface of at least the wireless portable processing device is in its Connect state, and:
if so, the method comprises keeping the radio access node femtonode functionality radio section and/or any other radio section in its on state; or
if not, the method comprises switching the detection radio interface of the wireless portable processing device to its Initiating state, the detection radio interface of the radio access node to its Advertising state, and switching off the femtonode functionality radio section and/or any other radio section.

According to the method of the invention, at said Stand by state the detection radio interfaces do not either transmit or check the reception of any radio packet.

For another embodiment, alternative to the above described referring to the establishment a short radio link, the reception of said low-power radio signal by said radio access node is performed by means of a detection radio interface supported by passive Near Field Communications Radio Frequency Identification, or NFC-RFID, comprising an Initiator device, and said wireless portable processing device also comprising a detection radio interface unit comprising a NFC-RFID Target device, the method comprising providing by said Initiator device a carrier field and answering thereto, by means of the Target device, by modulating existing field and sending the resulting modulated signal to the Initiator device, said modulated signal being said low-power radio signal.

The method comprises, for an embodiment, carrying out said switching on by performing the next steps:
detecting by said Initiator device said Target device, a NFC identification, or NFCIDn, being included in said resulting modulated signal; and
checking, the radio access node, if the retrieved NFCIDn is included in an accessible user equipments list, and if so, switching on, by means of the radio access node, its femtonode functionality radio section and/or any other radio section.

Once the femtonode functionality radio section and/or any other radio section is switched on, the method comprises, for an embodiment, checking, for a predetermined time, by means of the wireless portable processing device and the radio access node, if the wireless portable processing device is camping in the radio access node femtonode functionality, and:
if so, keeping the femtonode functionality radio section and/or any other radio section in the on state; or
if it is not camping in the femtonode functionality, switching off the femtonode functionality radio section and/or any other radio section.

By means of the method of the invention, a reduction of energy consumption and radio interference is achieved, which improves energy efficiency and data throughput, in the deployment of femtonodes at the customers' premises, and in general in the deployment of multi-interface telecommunication nodes, labeled as “Radio Access Node” in patent applications P200800878 and P200802049. This method makes it possible to switch on any radio interface only when the customer is in the interior of his/her premises.

A “Radio Access Node”, as it is described in the patent application P200800878, is an equipment that is connected to the access network, in order to provide it connectivity to the telecom operator network, and integrates as many wired and wireless interfaces as required for the provision of indoors connectivity, which can be embedded within the “Radio Access Node” or integrated in modular plug-in units to be inserted in the “Radio Access Nodes” Base Unit. The “Radio Access Node” could be also labeled as a multi-interface femtonode.

The “Radio Access Node”, for the provision of indoors wireless connectivity, makes use of the frequency bands that are available for a telecom operator; the Industrial Scientific Medical (ISM) free bands (e.g. 2.4-5 GHz), and proprietary licensed bangs (e.g. 3G, LTE bands), and in a scenario where many “Radio Access Nodes” are installed in many customers premises in the same building, so a high level of radio interference between “Radio Access Nodes” and a reduction in the available throughput is very likely.

The method of the invention, as described above, is intended for switching-off the radio sections of the “Radio Access Node”, and, depending on the embodiment, some other of its building blocks, when the customer is not at home, thus reducing the average interference level for the other “Radio Access Nodes” and improving the aggregated throughput. Another benefit for the customer is a reduction in the power consumption of the equipment.

The switching-off method is based on the automatic detection of the customer presence by means of a low-power radio interface activated in his/her mobile Equipment, for example a Bluetooth Low Energy or a Low Power UWB interface. This radio interface is, for an embodiment, always active in the Equipment but its low power characteristic does not degrade significantly the battery lifetime.

When the user arrives at home, the “Radio Access Node” detects the User Equipment low power radio interface (typical indoor range is in the order of 10 to 15 meters) and switches-on the required radio interfaces and other equipment blocks, and the opposite is done when the user leaves the home and low power radio interface connectivity is lost, switching-off what is required.

The invention describes the connection-disconnection method between the “Radio Access Node” and the portable User Equipment by means of the low power radio interface, the switching-on and off methods, the impact on the power consumption, interference level and throughput, the impact on 3GPP handovers, the remote management method specific for the on-off switching characteristic, and the application of User Equipment discovery for supporting other networking functionalities coordinated by the “Radio Access Node”.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 shows elements involved in the invention, for an embodiment, including a radio access node, a mobile user equipment and other communication devices, the dotted lines there illustrated indicating different communications established there between according to the method of the invention;

FIG. 2 shows the same elements of FIG. 1 but also depicting some internal radio sections of the radio access node which, according to the method of the invention, have been switched ON when the short range communication link, established between the detection radio interfaces of the radio access node and the mobile user equipment, is active;

FIG. 3 depicts the same elements of FIG. 2, but where the internal radio sections of the radio access node have been switched OFF due to the breaking of the short range communication link, for an embodiment of the method of the invention;

FIG. 4 is a flux diagram representing an embodiment of the method of the invention regarding a non-PLMN-assisted femtonode radio interface switching procedure;

FIG. 5 is a flux diagram similar to the one of FIG. 4, but for an embodiment of the invention regarding a non-PLMN-assisted with femto camping detection femtonode radio interface switching procedure;

FIG. 6 shows another embodiment of the method of the invention, by means of a flux diagram for a PLMN-assisted femtonode radio interface switching procedure;

FIG. 7 shows schematically the communication between the Radio Access Node and the portable User Equipment according to an embodiment of the method of the invention;

FIG. 8 is a flux diagram similar to that of FIG. 4, but for an embodiment where, instead of the femtonode radio interface, the switching procedure is applied to other radio interfaces of the radio access node;

FIG. 9 is a flux diagram similar to the one of FIG. 5, but also applied to other radio interfaces of the radio access node;

FIG. 10 is a flux diagram similar to the one of FIG. 6, but for an embodiment where the switching procedure is applied to other radio interfaces of the radio access node; and

FIG. 11 shows, by means of another flux diagram, an embodiment of the method of the invention regarding a NFC-assisted with femto camping detection for radio interface switching procedure.

### DETAILED DESCRIPTION OF SEVERAL EMBODIMENTS

### General Architecture Used by the Method of the Invention:

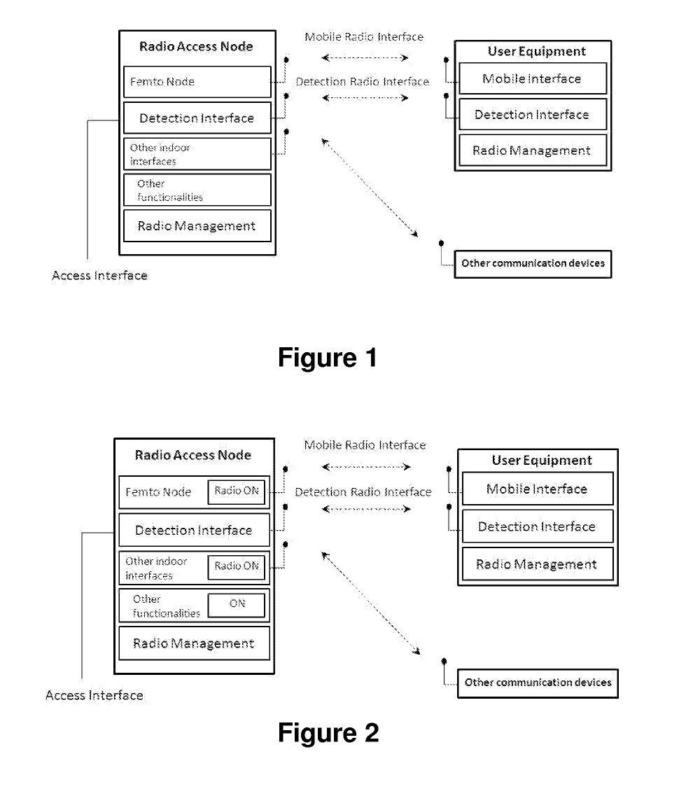

In the simplest embodiment of this invention, the elements shown in FIG. 1 and described subsequently are involved for applying the method of the invention.

A Radio Access Node (RAN), as it is described in patent applications P200800878 and P200802049, that is connected to the telecom operator core network through an Access Interface. A possible implementation of the Access Interface is an ADSL digital interface supported on the access copper pair. A Radio Access Node is an equipment that can incorporate one or many indoor communication interfaces, wireless or cabled, for the provision of indoor communication services.

For an embodiment, the Radio Access Node includes a femtonode for mobile wireless communications, that supports a Mobile Radio Interface, for example but not precluding any other radio interface, GSM, UMTS or LTE. For another possible embodiment the Radio Access Node includes any other interface that could be used for indoor communications, for example but not precluding other possibilities, Wi-Fi IEEE 802.11, Zigbee IEEE 802.15.4 or PLC IEEE P1901.

The Radio Access Node includes also a Detection Interface unit, for the transmission and reception of a Detection Radio Interface (DRI). The Detection Radio Interface is a short range radio interface intended for the detection of the User Equipment proximity to the radio Access Node. The Detection Interface unit performs all the functions in the Radio Access Node to support the Detection Radio Interface, for example Physical Layer radio transmission and reception, medium access control or link layer control. The Radio Access Node Detection Interface is identified by means of a Detection Radio Interface Identification number (DRI-ID) The Detection Radio Interface Identification number is a unique identifier for the Detection Interface unit; for example, and not precluding any other implementation, if the Detection Radio Interface is implemented by means of a Low Energy Bluetooth radio interface, the DRI-ID will be the Low Energy Bluetooth Device Address, as it is described in Bluetooth Core 4 specification, Volume 6 Section 1.3.

The Radio Access Node includes also a Radio Management unit. The purpose of the Radio Management unit is to determine where the User Equipment is and switching on or off the femtonode radio section and/or any other functional unit within the Radio Access Node.

The Radio Management unit of the Radio Access Node stores an Accessible User Equipments list, a list of Users Equipments that are authorized to connect to the Radio Access Node and their corresponding Detection Radio Interface Identification numbers (DRI-ID).

In one embodiment of this invention, the User Equipments are identified by means of their IMSIs or International Mobile Subscriber Identities. When a User Equipment tries to camp on a femtocell, sending a Location Update message, it is required to send its IMSI which identifies the subscriber in order to validate the access rights. If the IMSI is included in the Accessible User Equipments list, the Location Update Message will be progressed to the mobile core network, and the User Equipment will camp on the femtocell. On the contrary, if the IMSI is not in the list, the femtonode will reject the location updating procedure with a Location Update Reject message.

The Radio Management unit stores also a list of the cells that are detected by the femtonode functionality of the Radio Access Node. These cells are Public Land Mobile Network (PLMN) macrocells, for example but not precluding any other implementation, for the GSM, UMTS or LTE standards. The cells list is ordered from strongest to weakest, with a number of cells that can be predefined by the service provider or the user. A subset of the strongest cells is defined as the macrocells that will provide PLMN mobile coverage to a User Equipment when it is in the neighbourhood of the Radio Access Node, and their cell identifiers will be stored in a Femto Overlapping Macrocells list. The cells are identified by means of their Cell Global Identification (CGI) number, a number that uniquely identifies a specific cell within its location area, network, and country. The CGI is composed of the MCC (Mobile Country Code), MNC (Mobile Network Code), LAC (Location Area Code), and Cell Identity (CI). The Femto Overlapping Macrocells list will be generated the first time the femtonode functionality of the Radio Access Node is activated, and every time there is a change in the macrocells that are detected by femtonode functionality. Detection of macrocells, is carried out periodically and is usually performed by the femtonode radio receiver itself, and therefore femtonode interface is out of service for its duration.

The Radio Access Node can include any other functionality that could be necessary for the provision of indoor communications and access to the telecom operator network. For example, but not precluding any other possibility, the Radio Access Node can include an ADSL modem, a ONT functionality, a router, an internal data storage unit or IPTV receiver and de-encryption capabilities.

A User Equipment (UE) is the equipment that a person uses to access any communication service through the Radio Access Node. A possible embodiment of the User Equipment is a mobile phone or cellular, that can communicate with the femtonode functionality of the Radio Access Node by means of a Mobile Radio Interface, for example but not precluding any other radio interface, GSM, UMTS or LTE. Another possible embodiment of the User Equipment is a Wi-Fi IEEE 802.11 Access Point.

In this invention, the User Equipment includes also a Detection Interface, for the transmission and reception of a Detection Radio Interface. The Detection Radio Interface is a short range radio interface intended for the detection of the Radio Access Node proximity to the User Equipment. The Detection Interface unit performs all the functions in the User Equipment to support the Detection Radio Interface, for example Physical Layer radio transmission and reception, medium access control or link layer control.

In this invention, the User Equipment includes also a Radio Management unit. The purpose of the Radio Management unit is to determine where the User Equipment is, and helping in the process of switching on or off the femtonode radio section and/or any other functional unit within the Radio Access Node. The User Equipment Detection Interface is identified by means of a Detection Radio Interface Identification number (DRI-ID) The Detection Radio Interface Identification number is a unique identifier for the Detection Interface unit; for example, and not precluding any other implementation, if the Detection Radio Interface is implemented by means of a Bluetooth Low Energy radio interface, the DRI-ID will be the Bluetooth Low Energy Device Address, as it is described in Bluetooth Core 4 specification, Volume 6 Section 1.3.

The Radio Management unit of the User Equipment stores an Accessible Radio Access Nodes list, a list of Radio Access Nodes to which it can connect. In one embodiment of this invention, this is a list of Cell Global Identification (CGI) numbers that are radiated by femtonodes and their corresponding Radio Access Node Detection Radio Interface Identification number (DRI-ID). The User Equipment Radio Management unit can also store the Radio Access Node Femto Overlapping Macrocells list.

The purpose of the Detection Interface units in both the Radio Access Node and the User Equipment is to support a Detection Radio Interface, that is used to establish a short range wireless communication link between the Radio Access Node and the User Equipment.

In one embodiment of this invention, the short range wireless communication link supported by the Detection Radio Interface makes it possible to determine when the User Equipment is located a short distance away from the Radio Access Node, in the order of a few tens of meters. Once a short range wireless communication link is established between the Radio Access Node and the User Equipment, the Radio Management unit at the Radio Access Node proceeds to switch on any functional unit in the Radio Access Node that could be considered necessary, and in particular the radio section of the femtonode functionality, or any other radio section included in the Radio Access Node. On the other hand, if the short range communication link is broken, the Radio Management unit at the Radio Access Node proceeds to switch off any functional unit in the Radio Access Node that could be considered necessary, and in particular the radio section of the femtonode functionality, or any other radio section included in the Radio Access Node. This procedure can be applied to switch on and off any other radio section in the Radio Access Node; for example and not precluding any other possibility, the radio section of a Wi-Fi IEEE 802.11 interface.

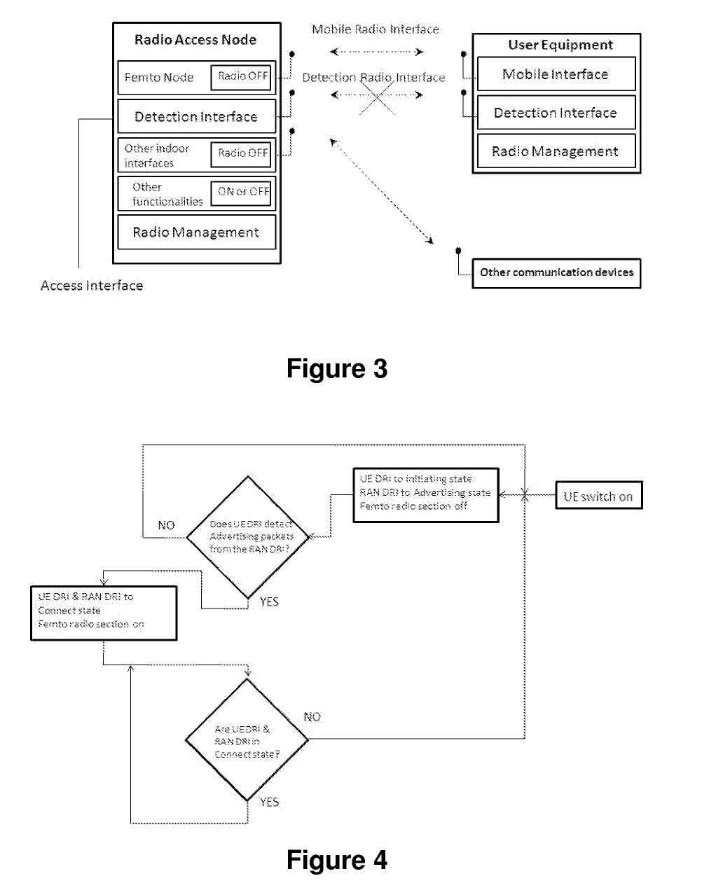

In this way, it is possible to ensure that the desired units of the Radio Access Node, and in particular the radio section of the femtonode functionality, can be operative only when the User Equipment is in the interior of the user premises or very close to it. FIGS. 2 and 3 show, in a very simplified way, the switching on and off procedure according to two embodiments of the method of the invention. FIG. 2 shows that when the short range communications link, supported by the Detection Radio Interface, is active, the radio section of the Radio Access Node, and other functionalities, are switched on. On the other hand, FIG. 3 shows that when the short range communications link, supported by the Detection Radio Interface, is not active, the radio section of the Radio Access Node, and other functionalities, can be switched off.

In one embodiment of this invention, the Detection Radio Interface is a Basic Rate/Enhanced Data Rate Bluetooth IEEE 802.15.1 radio interface. In another embodiment of this invention, the Detection Radio Interface is a Bluetooth Low Energy IEEE 802.15.1 radio interface. In yet another embodiment of this invention, the Detection Radio Interface is a Bluetooth Low Energy IEEE 802.15.1 radio interface that makes use of the proximity profile for mobile phones in order to perform automatic actions. In another embodiment of this invention, the Detection Radio Interface is an Ultra-Wideband IEEE 802.15.4a radio interface. For another embodiment the Detection Radio Interface is a Zigbee PRO Feature Set or any solution based on IEEE 802.15.4-2006 radio interface. This invention does not preclude the use of any other radio interface to implement the Detection Radio Interface, provided it is a short range radio interface that makes it possible to determine that the User Equipment is within a few tens of meters from the Radio Access Node.

### Non-PLMN-Assisted Femtonode Radio Interface Switching Procedure

FIG. 4 illustrates, by means of a state diagram, an embodiment of the method of the invention, where the switching on and off procedure of the radio section of the femtonode functionality of the Radio Access Node relies only in a direct communication between the Radio Access Node and the User Equipment, with no assistance from the Public Land Mobile Network (PLMN).

The description of the process that will be done is based on a Bluetooth Low Energy radio interface for the implementation of the Detection Radio Interface; this implementation is only for indicative purposes and used only to provide a detailed description of the process, and do not preclude any other implementation of the Detection Radio Interface.

As it is depicted in FIG. 4, the switching procedure is as follows. When the User Equipment is turned on, the User Equipment Detection Radio Interface will be set to the Initiating default state. Regarding the Radio Access Node, its Detection Radio Interface will be in its default Advertising state, and its femtonode functionality radio section will be in its default off state. In the Initiating state, the User Equipment is searching for advertising radio packets emitted from any Radio Access Node Detection Radio Interface included in the Accessible Radio Access Nodes list. If the User Equipment Detection Radio Interface does not detect any advertising packet from some Radio Access Node included in the list, it remains in the Initiating state.

If advertising packets are detected at the User Equipment, the User Equipment checks if the Radio Access Node DRI-ID of the advertising Detection Radio Interface is included in its Accessible Radio Access Nodes list. If it is in the list, both the User Equipment and the Radio Access Node Detection Radio Interfaces will change to the Connect status. Once the connection of the short range radio link between the User Equipment and the Radio Access Node Detection Interface units has been established, the Radio Access Node will switch on the radio section of its femtonode functionality.

For the period of time when the femtonode functionality of the Radio Access Node is switched off and is not radiating, any other Radio Access Node with femtonode functionality can be switched on radiate with the same pair of UARFCN and PSC values. Before switching on the radio section of its femtonode functionality, the Radio Access Node has to check the validity of the previously used radio physical channel. This auto-configuration procedure is carried out whenever the femtonode functionality is switched on. In one embodiment of this invention, a UMTS femtonode functionality checks the previously used UTRA Absolute Radio Frequency Channel Number (UARFCN) and the Primary Scrambling Code (PSC), and in the case they are not in use it radiates the signal with the same values of UARFCN and PSC as used before switching off. In the case these values are in use, the femtonode selects the UARFCN and PSC with lower power detected from a set of possible values.

In the case that the User Equipment and the Radio Access Node Detection Radio Interfaces lose the Connect state, they return to their respective Initiating and Advertising status, and the Radio Access Node femtonode functionality radio section switches off.

The femtonode functionality radio transmitter section remains switched off until the next time the User Equipment and Radio Access Node Detection Radio Interfaces change again to the Connect status.

In one embodiment of this invention, the femtonode functionality radio receiver section may be switched on periodically to perform the macrocell detection and therefore update the Femto Overlapping Macrocells list. In another embodiment of this invention, the Femto Overlapping Macrocells list is updated immediately after switching off the femtonode radio transmitter section and before switching off the radio receiver section in order to minimize the number of macrocell detection procedures carried out when the femtonode functionality transmitter radio section is on, because this procedure implies that femtonode interface is out of service for its duration.

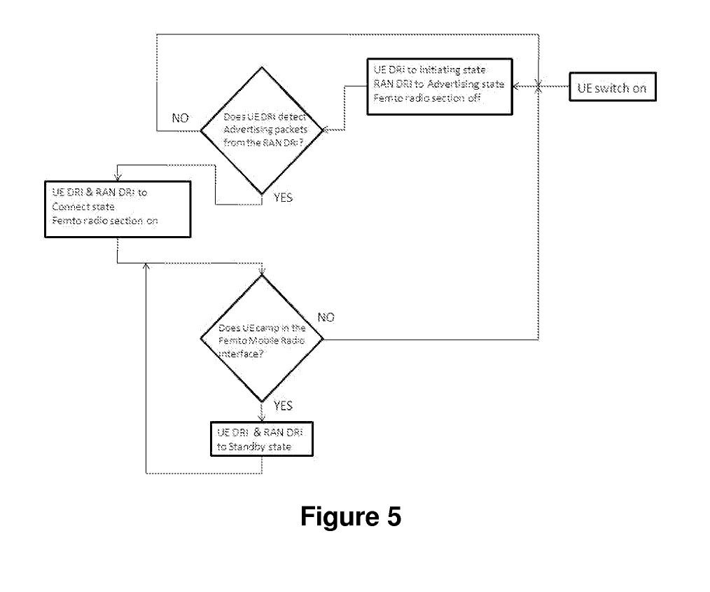

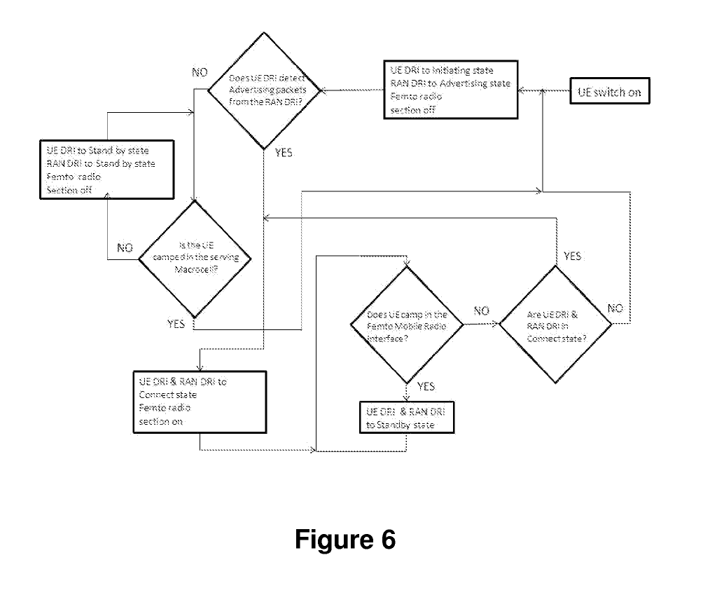

In another embodiment of this invention, represented by the state diagram of FIG. 5, the switching on and off procedure of the radio section of the femtonode functionality of the Radio Access Node relies in a direct communication between the Radio Access Node and the User Equipment, and detects also when the User Equipment Mobile Interface camps in the Radio Access Node femtonode functionality to switch the User Equipment and the Radio Access Node Detection Radio Interfaces to Stand by state.

The description of the process that will be done is based on the Bluetooth Low Energy radio interface for the implementation of the Detection Radio Interface; this implementation is only for indicative purposes and used only to provide a detailed description of the process, and do not preclude any other implementation of the Detection Radio Interface.

As it is depicted in FIG. 5, the switching procedure is as follows. When the User Equipment is turned on, the User Equipment Detection Radio Interface will be set to the Initiating default state. Regarding the Radio Access Node, its Detection Radio Interface will be in its default Advertising state, and its femtonode functionality radio section will be in its default off state. In the Initiating state, the User Equipment is searching for advertising radio packets emitted from any Radio Access Node Detection Radio Interface included in the Accessible Radio Access Nodes list. If the User Equipment Detection Radio Interface does not detect any advertising packet from some Radio Access Node included in the list, it remains in the Initiating state.

If advertising packets are detected at the User Equipment, the User Equipment checks if the Radio Access Node DRI-ID of the advertising Detection Radio Interface is included in its Accessible Radio Access Nodes list. If it is in the list, both the User Equipment and the Radio Access Node Detection Radio Interfaces will change to the Connect status. Once the connection of the short range radio link between the User Equipment and the Radio Access Node Detection Interface units has been established, the Radio Access Node will switch on the radio section of its femtonode functionality.

When the radio section of the femtonode functionality is switched on, the User Equipment Mobile Interface unit will try to camp in the femtonode cell. Both the Radio Access Node and the User Equipment will wait for a predetermined time (Camping Check Time) to check if the User Equipment has camped in the femtonode cell.

When the User Equipment tries to camp on a femtocell with a Location Update message, it is required to send the IMSI which identifies the subscriber in order to validate the access rights. If the IMSI is included in the Accessible User Equipments list, the Location Update Message will be progressed to the mobile core network, and the User Equipment will camp on the femtocell. On the contrary, if the IMSI is not in the Accessible User Equipments list, the femtonode will reject the location updating procedure with a Location Update Reject message.

The Radio Management unit of the User Equipment can check if the Mobile Interface is camped in the Radio Access Node femtonode functionality requesting to the Mobile Interface the Cell Global Identification of the cell where it is camped, for example and not precluding any other implementation, by means of standard AT commands, as defined in 3GPP TS 27.007 “3rd Generation Partnership Project; Technical Specification Group Core Network and Equipments; AT command set for User Equipment (UE)”, and checking if the reported Cell Global Identification is in the stored Accessible Radio Access Nodes list.

If the User Equipment has camped in the femtonode cell before the Camping Check Time has elapsed, both the Radio Access Node and the User Equipment Detection Radio Interfaces will be switched to the Stand by state. In the stand by state, the Detection Radio Interface does not either transmit or check the reception of any radio packet. The rationale for switching to the Stand by state is twofold; saving battery energy resources in the User Equipment, and reducing the radio spectrum occupation and the level of interference produced by the Detection Radio Interface.

Once the Camping Check Time has elapsed, if the User Equipment has not camped in the femtonode cell, the User Equipment Detection Radio Interface will switch to the Initiating state, and the Radio Access Node Detection Radio Interface will switch to the Advertising state, and the radio section of the femtonode functionality of the Radio Access Node will be switched off.

### PLMN-Assisted Femtonode Radio Interface Switching Procedure

Another possible embodiment of this invention involves the collaboration from the Public Land Mobile Network (PLMN) to minimize the period of time during which the Detection Radio Interface is active in the User Equipment and/or in the Radio Access Node. Some examples of Public Land Mobile Networks are the GSM, UMTS or LTE network, but it is not precluded the use of any other kind of PLMN.

The goal of this procedure is to keep the Detection Radio Interface of both the User Equipment and the Radio Access Node in Stand by state for as long as possible, in order to reduce the User Equipment battery power consumption, and to reduce the radio interference produced by the Detection Radio Interface of both the User Equipment and the Radio Access Node. This procedure keeps the Radio Access Node and the User Equipment Detection Radio Interfaces in Stand by state all the time, with the exception of the occasions when the User Equipment is camped in some of the macrocells listed in the Femto Overlapping Macrocells list of the femtonode, but not camped in the femtonode itself, as in these occasions the User Equipment Detection Radio Interfaces will switch to the Initiating state, and the Radio Access Node Detection Radio Interfaces will switch to the Advertising state.

The description of the process that will be done is based on the Bluetooth Low Energy radio interface for the implementation of the Detection Radio Interface; this implementation is only for indicative purposes and used only to provide a detailed description of the process, and do not preclude any other implementation of the Detection Radio Interface.

The state diagram of the PLMN-assisted femtonode radio access section switching procedure is depicted in FIG. 6.

As shown in FIG. 6, the switching procedure is as follows. When the User Equipment is turned on, the User Equipment Detection Radio Interface will be set to the Initiating default state. Regarding the Radio Access Node, its Detection Radio Interface will be in its default Advertising state, and its femtonode functionality radio section will be in its default off state. In the Initiating state, the User Equipment is searching for advertising radio packet emitted from the Radio Access Node Detection Radio Interface.

If the User Equipment Detection Radio Interface does not detect the advertising packets from the Radio Access Node, the Radio Management unit of the User Equipment checks if the User Equipment Mobile Interface is camped in some of the macrocells included in the Femto Overlapping Macrocells list. The Radio Access Node reports to the User Equipment the Femto Overlapping Macrocells list by means of a procedure that will be called Femto Overlapping Macrocells List Reporting, that will be described later in this section.

If it is not camping in any of these macrocells, and no advertising packets from the Radio Access Node are detected, the User Equipment Radio Management unit determines that the User Equipment is not either in the neighbourhood of its femtonode or camped in it, so it switches its Detection Radio Interface to Stand by status, in order to save battery power. Then, the User Equipment Radio Management unit orders to the User Equipment Mobile Interface unit to communicate to the Radio Access Node Radio Management unit to switch its Detection Radio Interface to Stand by state, following a procedure that will called Macro Identification and RAN DRI Switching, that will be described later in this section. This is done in order to reduce the level of radio interference generated by the Radio Access Node Detection Radio Interface.

If the User Equipment Detection Radio Interface does not detect the advertising packets from the Radio Access Node, the Radio Management unit of the User Equipment checks if the User Equipment Mobile Interface is camped in some of the macrocells included in the Femto Overlapping Macrocells list. If it is camping in any of these macrocells, and no advertising packets from the Radio Access Node are detected, the User Equipment Radio Management unit determines that the User Equipment is in the neighbourhood of its femtonode but not camped in it, so it switches its Detection Radio Interface to Initiating state (in the case it were in Stand by state), and the User Equipment Radio Management unit orders to the User Equipment Mobile Interface unit to communicate to the Radio Access Node Radio Management unit to switch its Detection Radio Interface to Advertising state (in the case it were in Stand by state), following a procedure that will be described later in this section. This is done in order to allow the establishment of the short range communications link supported by the Detection Radio Interface between the Radio Access Node and the User Equipment, once the Radio Access Node and the User Equipment are close enough to each other.

If advertising packets are detected at the User Equipment, the User Equipment checks if the Radio Access Node DRI-ID of the advertising Detection Radio Interface is included in its list of authorized Radio Access Nodes. If it is in the list, both the User Equipment and the Radio Access Node Detection Radio Interfaces will change to the Connect status. Once the connection of the short range radio link between the User Equipment and the Radio Access Node Detection Interface units has been established, the Radio Access Node will switch on the radio section of its femtonode functionality.

For the period of time when the femtonode functionality of the Radio Access Node is switched off and is not radiating, any other Radio Access Node with femtonode functionality can be switched on radiate with the same pair of UARFCN and PSC values. Before switching on the radio section of its femtonode functionality, the Radio Access Node has to check the validity of the previously used radio physical channel. This autoconfiguration procedure is carried out whenever the femtonode functionality is switched on. In one embodiment of this invention, a UMTS femtonode functionality checks the previously used UTRA Absolute Radio Frequency Channel Number (UARFCN) and the Primary Scrambling Code (PSC), and in the case they are not in use it radiates the signal with the same values of UARFCN and PSC as used before switching off. In the case these values are in use, the femtonode selects the UARFCN and PSC with lower power detected from a set of possible values.

When the radio section of the femtonode functionality is switched on, the User Equipment Mobile Interface unit will try to camp in the femtonode cell. Both the Radio Access Node and the User Equipment will wait for a predetermined time (Camping Check Time) to check if the User Equipment has camped in the femtonode cell.

If the User Equipment has camped in the femtonode cell after the Camping Check Time has elapsed, both the Radio Access Node and the User Equipment Detection Radio Interfaces will be switched to the Stand by state. In the stand by state, the Detection Radio Interface does not either transmit or check the reception of any radio packet. The rationale for switching to the Stand by state is twofold; saving battery energy resources in the User Equipment, and reducing the radio spectrum occupation and the level of interference produced by the Detection Radio Interface.

Once the Camping Check Time has elapsed, if the User Equipment has not camped in the femtonode cell, the User Equipment Detection Radio Interface will check if the Detection Radio Interface is still in Connect state with the Radio Access Node. If the answer is yes, the femtonode radio section in the Radio Access Node will remain in on state, but if the answer is no the User Equipment Detection Radio Interface switch to the Initiating state, and the Radio Access Node Detection Radio Interface will switch to the Advertising state, and the radio section of the femtonode functionality of the Radio Access Node will be switched off.

The femtonode functionality radio transmitter section remains switched off until the next time the User Equipment and Radio Access Node Detection Radio Interfaces change again to the Connect status.

In one embodiment of this invention, the radio receiver section of the femtonode functionality is periodically switched on, in order to perform the macrocells detection procedure for updating the Femto Overlapping Macrocells list. In another embodiment of this invention, the Femto Overlapping Macrocells list is updated immediately after switching off the femtonode radio transmitter section and before switching off the radio receiver section in order to minimize the number of macrocell detection procedures carried out when the femtonode functionality transmitter radio section is on, because this procedure implies that femtonode interface is out of service for its duration.

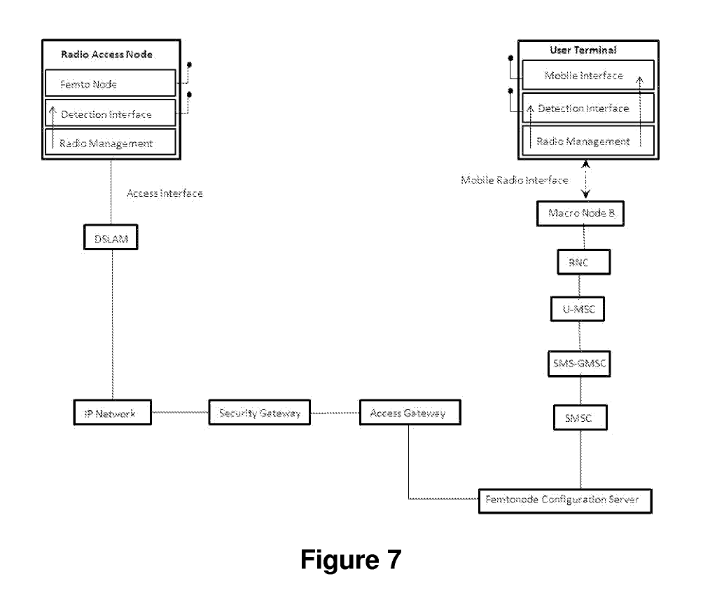

Regarding the Macro Identification and RAN DRI Switching procedure, the process by which the User Equipment Radio Management unit orders to the User Equipment Mobile Interface unit to communicate to the Radio Access Node Radio Management unit to switch its Detection Radio Interface to Stand by state or to Advertising state, FIG. 7 shows a possible embodiment of the process, for the case the UMTS radio interface were used as Mobile Interface and the Short Message Service (SMS) were also used, but this invention does not preclude the use of any other implementation of the Mobile Interface or any other procedure to communicate information between the User Equipment and the Radio Access Node.

The Macro Identification and RAN DRI Switching procedure begins when the User Equipment does not detect advertising radio packets from the Radio Access Nodes included in the Accessible Radio Access Nodes list, and checks if the Mobile Radio section of the User Equipment camps in any of the macrocells stored in the Femto Overlapping Macrocells list. The Mobile Radio section can identify in which macrocell is camped by extracting the Cell Global Identification of the serving Base Station where it is camped, and this information can be retrieved by the Radio Management section by means of standard AT commands, as defined in 3GPP TS 27.007 “3rd Generation Partnership Project; Technical Specification Group Core Network and Equipments; AT command set for User Equipment (UE)”.

If the User Equipment is not camping in any of the cells in the Femto Overlapping Macrocells list, and no advertising packets from the Detection Radio Interface of a Radio Access Node included in the Accessible Radio Access Nodes list are detected, the User Equipment Radio Management unit determines that the User Equipment is not either in the neighbourhood of its femtonode or camped in it, so it switches its Detection Radio Interface to Stand by status and requests the Radio Access Node Detection Radio Interface to switch to the Stand by state. On the other hand, if the User Equipment is camping in some of the cells included in the Femto Overlapping Macrocells list, and no advertising packets from the Detection Radio Interface of a Radio Access Node included in the Accessible Radio Access Nodes list are detected, the User Equipment Radio Management unit determines that the User Equipment is in the neighbourhood of its femtonode but camped in it, so it switches its Detection Radio Interface to the Initiating state (if it is in the Stand by state) and requests the Radio Access Node Detection Radio Interface to switch to the Advertising state (if it is in the Stand by state).

The process to request the Radio Access Node Detection Radio Interface to switch to the Stand by or the Advertising states, in the case that the UMTS Short Message Service is used, proceeds as follows.

The Radio Management unit of the User Equipment requests to send an SMS to the telecom operator PLMN, as an example but not precluding any other implementation, by means of standard AT commands to the Mobile Interface. This SMS will be called Switching Request SMS, and it includes a) the IMSI of the requesting User Equipment, b) the CGI of the femtocell within the Radio Access Node to which the request is done, c) the specific request that is done, that can be switching the Radio Access Node Detection Radio Interface to the Stand by state or to the Advertising state, d) a specific number, called Femtonode Configuration Server Number, as a destination of the SMS, that will be used by the Short Message Service Center to determine that the SMS is a Switching Request SMS. The Switching Request SMS is received in a macrocell Node B, which is connected to a Radio Network Controller (RNC), which is connected to an UMTS Mobile Switching Center (U-MSC), which is connected to the Short Message Service Gateway MSC (SMS-GMSC), which finally directs the Switching Request SMS to the Short Message Service Center. The Short Message Service Center processes the Switching Request SMS as any other SMS, but when it detects that the destination number is in a locally stored list of Femtonode Configuration Server Numbers, sends the contents of the Switching Request SMS to the Femtonode Configuration Server.

When the Femtonode Configuration Server receives a Switching Request SMS, it checks if the requesting User Equipment is one of the User Equipments that is authorized to camp in the Radio Access Node femtonode, and in the case it is authorized, the Femtonode Configuration Server sends an instruction to the Radio Access Node Radio Management unit to switch its Detection Radio Interface to the Stand by or the Advertising states. In one possible embodiment of this invention, when the Radio Access Node and its femtonode functionality are connected to the telecom operator through an ADSL Access Network, this order is transmitted from the Femtonode Configuration Server to a Security Gateway, from the Security Gateway through an IP network to the ADSL DSLAM, and from the DSLAM through the copper access line to the Radio Access Node Radio Management unit.

Regarding the Femto Overlapping Macrocells List Reporting procedure, the process by which the Radio Access Node reports to the User Equipment the Femto Overlapping Macrocells List, FIG. 7 shows a possible embodiment of the process, for the case the UMTS radio interface were used as Mobile Interface and the Short Message Service (SMS) were also used, but this invention does not preclude the use of any other implementation of the Mobile Interface or any other procedure to communicate information between the User Equipment and the Radio Access Node.

The Femto Overlapping Macrocells List Reporting procedure begins every time there is a change in the Radio Access Node Femto Overlapping Macrocells list. When there is a change, and including the first time that the list is generated, the Radio Management unit of the Radio Access Node will send the Femto Overlapping Macrocells list to the Femtonode Configuration Server, through the ADSL line, DSLAM, IP network, Security Gateway and the Access Gateway. The Femtonode Configuration Server will store the Femto Overlapping Macrocells list for every Radio Access Node femtonode functionality that it can control, and at the same time it keeps a list of the User Equipments that can connect to every Radio Access Node femtonode functionality. When a new version of the Femto Overlapping Macrocells list is received at the Femtonode Configuration Server, or the first time this list is received, the Femtonode Configuration Server requests to the Short Message Service Center to send an SMS to the User Equipments that can connect to that specific Radio Access Node femtonode functionality. This SMS includes the identification of the Radio Access Node femtocell: the CGI, and the Femto Overlapping Macrocells list.

### Non-PLMN-Assisted Other Radio Interfaces Switch On and Off Procedures:

In one embodiment of this invention, the switching on and off procedure of any other radio section of the Radio Access Node relies only in a direct communication between the Radio Access Node and the User Equipment, with no assistance from the Public Land Mobile Network (PLMN). Some examples of any other radio interface, that do not preclude any other possibility, are a Wi-Fi IEEE 802.11 radio interface or Zigbee PRO Feature Set or any other solution based on IEEE 802.15.4.

The description of the process that will be done is based on the Bluetooth Low Energy radio interface for the implementation of the Detection Radio Interface; this implementation is only for indicative purposes and used only to provide a detailed description of the process, and do not preclude any other implementation of the Detection Radio Interface.

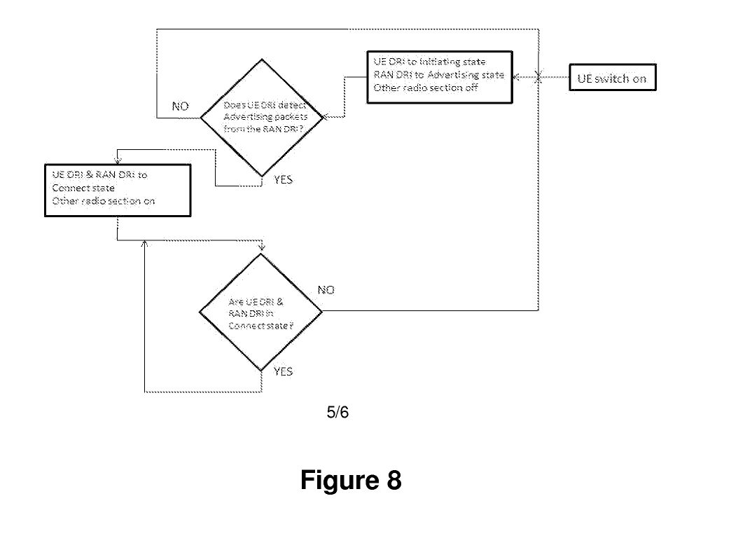

The state diagram of the Non-PLMN-assisted other radio interfaces switch on and off procedure is depicted in FIG. 8.

As it is depicted in FIG. 8, the switching procedure is as follows. When the User Equipment is turned on, the User Equipment Detection Radio Interface will be set to the Initiating default state. Regarding the Radio Access Node, its Detection Radio Interface will be in its default Advertising state, and any other radio interface section could be in its default off state. In the Initiating state, the User Equipment is searching for advertising radio packets emitted from any Radio Access Node Detection Radio Interface included in the Accessible Radio Access Nodes list. If the User Equipment Detection Radio Interface does not detect any advertising packet from some Radio Access Node included in the list, it remains in the Initiating state.

If advertising packets are detected at the User Equipment, the User Equipment checks if the Radio Access Node DRI-ID of the advertising Detection Radio Interface is included in its Accessible Radio Access Nodes list. If it is in the list, both the User Equipment and the Radio Access Node Detection Radio Interfaces will change to the Connect status. Once the connection of the short range radio link between the User Equipment and the Radio Access Node Detection Interface units has been established, the Radio Access Node will switch on any other radio section that could be included in it.

In the case that the User Equipment and the Radio Access Node Detection Radio Interfaces lose the Connect state, they return to their respective Initiating and Advertising status, and any Radio Access Node radio section can be switched off.

In another embodiment of this invention, the switching on and off procedure of any other radio section of the Radio Access Node relies in a direct communication between the Radio Access Node and the User Equipment, and detects also when the User Equipment Mobile Interface camps in the Radio Access Node femtonode functionality to switch the User Equipment and the Radio Access Node Detection Radio Interfaces to Stand by state.

The description of the process that will be done is based on the Bluetooth Low Energy radio interface for the implementation of the Detection Radio Interface; this implementation is only for indicative purposes and used only to provide a detailed description of the process, and do not preclude any other implementation of the Detection Radio Interface.

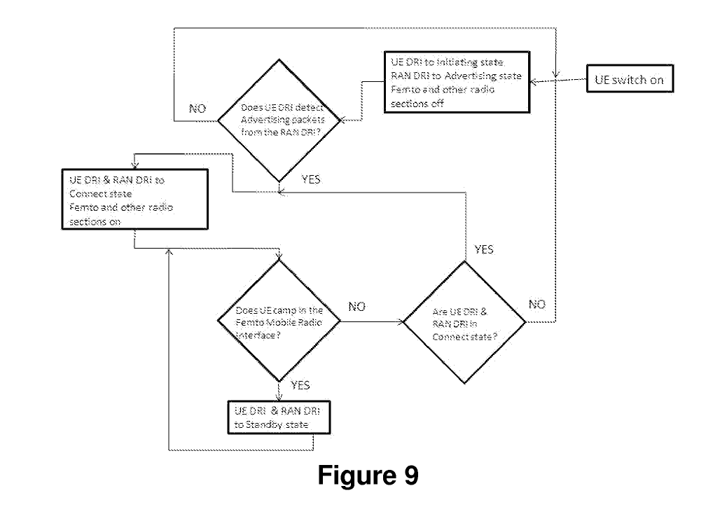

The state diagram of Non-PLMN-assisted with femto camping detection other radio interfaces switching procedure is depicted in FIG. 9.

As it is depicted in FIG. 9, the switching procedure is as follows. When the User Equipment is turned on, the User Equipment Detection Radio Interface will be set to the Initiating default state. Regarding the Radio Access Node, its Detection Radio Interface will be in its default Advertising state, and its femtonode functionality radio section and other radio sections will be in their default off state. In the Initiating state, the User Equipment is searching for advertising radio packets emitted from any Radio Access Node Detection Radio Interface included in the Accessible Radio Access Nodes list. If the User Equipment Detection Radio Interface does not detect any advertising packet from some Radio Access Node included in the list, it remains in the Initiating state.

If advertising packets are detected at the User Equipment, the User Equipment checks if the Radio Access Node DRI-ID of the advertising Detection Radio Interface is included in its Accessible Radio Access Nodes list. If it is in the list, both the User Equipment and the Radio Access Node Detection Radio Interfaces will change to the Connect status. Once the connection of the short range radio link between the User Equipment and the Radio Access Node Detection Interface units has been established, the Radio Access Node will switch on the radio section of its femtonode functionality and/or any other radio section that could be included in the Radio Access Node.

Before switching on the radio section of its femtonode functionality, the Radio Access Node has to check the validity of the previous radio physical channel radiated, which has been selected after scanning radio environment, and therefore, discarding any radio physical channel which is being used in order to avoid interference. This autoconfiguration procedure is carried out whenever the femtonode functionality and/or any other radio section is switched on.

When the radio section of the femtonode functionality is switched on, the User Equipment Mobile Interface unit will try to camp in the femtonode cell. Both the Radio Access Node and the User Equipment will wait for a predetermined time (Camping Check Time) to check if the User Equipment has camped in the femtonode cell.

If the User Equipment has camped in the femtonode cell after the Camping Check Time has elapsed, both the Radio Access Node and the User Equipment Detection Radio Interfaces will be switched to the Stand by state. In the stand by state, the Detection Radio Interface does not either transmit or check the reception of any radio packet. The rationale for switching to the Stand by state is twofold; saving battery energy resources in the User Equipment, and reducing the radio spectrum occupation and the level of interference produced by the Detection Radio Interface.

Once the Camping Check Time has elapsed, if the User Equipment has not camped in the femtonode cell, the User Equipment Detection Radio Interface will check if the Detection Radio Interface is still in Connect state with the Radio Access Node. If the answer is yes, the femto radio section and other radio interfaces in the Radio Access Node will remain in on state, but if the answer is no the User Equipment Detection Radio Interface will switch to the Initiating state and the Radio Access Node Detection Radio Interface will switch to the Advertising state, and the radio section of the femtonode functionality and any other radio section within the Radio Access Node will be switched off.

The femtonode functionality radio transmitter section remains switched off until the next time the User Equipment and Radio Access Node Detection Radio Interfaces change again to the Connect status. However, the femtonode functionality radio receiver section may be switched on periodically to perform the macrocell detection and therefore update the Femto Overlapping Macrocells list. In fact, it could be updated immediately after switching off the radio transmitter section and before switching off the radio receiver section in order to minimize the number of macrocell detection procedures carried out when the femtonode functionality transmitter radio section is on.

### PLMN-Assisted Other Radio Interface Switching Procedure:

Another possible embodiment of this invention involves the collaboration from the Public Land Mobile Network (PLMN) to minimize the period of time during which the Detection Radio Interface is active in the User Equipment and/or in the Radio Access Node. Some examples of Public Land Mobile Networks are the GSM, UMTS or LTE network, but it is not precluded the use of any other kind of PLMN. This procedure is intended for the switching of any other radio section that could be included in the Radio Access Node; some examples of any other radio interfaces, that do not preclude any other possibility, are a Wi-Fi IEEE 802.11 radio interface or ZigBee PRO Feature Set or any IEEE 802.15.4 based solution radio interface.

The goal of this procedure is to keep the Detection Radio Interface of both the User Equipment and the Radio Access Node in Stand by state for as long as possible, in order to reduce the User Equipment battery power consumption, and to reduce the radio interference produced by the Detection Radio Interface of both the User Equipment and the Radio Access Node. This procedure keeps the Radio Access Node and the User Equipment Detection Radio Interfaces in Stand by state all the time, with the exception of the occasions when the User Equipment is camped in the closest macrocell to the femtonode but not camped in the femtonode itself, as in these occasions the User Equipment Detection Radio Interfaces will switch to the Initiating state, and the Radio Access Node Detection Radio Interfaces will switch to the Advertising state.

The description of the process that will be done is based on the Bluetooth Low Energy radio interface for the implementation of the Detection Radio Interface; this implementation is only for indicative purposes and used only to provide a detailed description of the process, and do not preclude any other implementation of the Detection Radio Interface.

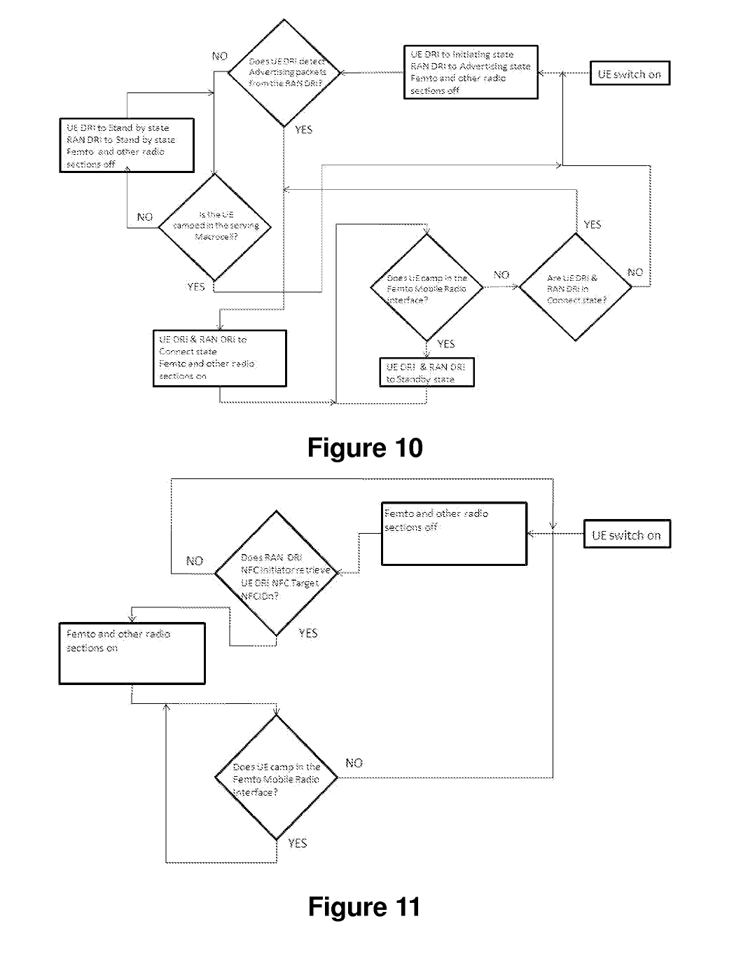

The state diagram of the PLMN-assisted femtonode radio access section and other radio interface switching procedure is depicted in FIG. 10.

As it is depicted in FIG. 10, the switching procedure is as follows. When the User Equipment is turned on, the User Equipment Detection Radio Interface will be set to the Initiating default state. Regarding the Radio Access Node, its Detection Radio Interface will be in its default Advertising state, and its femtonode functionality radio section and any other radio section will be in their default off state. In the Initiating state, the User Equipment is searching for advertising radio packet emitted from the Radio Access Node Detection Radio Interface.

If the User Equipment Detection Radio Interface does not detect the advertising packets from the Radio Access Node, the Radio Management unit of the User Equipment checks if the User Equipment Mobile Interface is camped in some of the macrocells included in the Femto Overlapping Macrocells list. The Radio Access Node reports to the User Equipment the Femto Overlapping Macrocells list by means of the procedure called Femto Overlapping Macrocells List Reporting. If it is not camping in any of these macrocells, and no advertising packets from the Radio Access Node are detected, the User Equipment Radio Management unit determines that the User Equipment is not either in the neighbourhood of its femtonode or camped in it, so it switches its Detection Radio Interface to Stand by status, in order to save battery power.

Then, the User Equipment Radio Management unit orders to the User Equipment Mobile Interface unit to communicate to the Radio Access Node Radio Management unit to switch its Detection Radio Interface to Stand by state, following a procedure called Macro Identification and RAN DRI Switching. This is done in order to reduce the level of radio interference generated by the Radio Access Node Detection Radio Interface.

If the User Equipment Detection Radio Interface does not detect the advertising packets from the Radio Access Node, the Radio Management unit of the User Equipment checks if the User Equipment Mobile Interface is camped in some of the macrocells included in the Femto Overlapping Macrocells list. If it is camping in any of these macrocells, and no advertising packets from the Radio Access Node are detected, the User Equipment Radio Management unit determines that the User Equipment is in the neighbourhood of its femtonode but not camped in it, so it switches its Detection Radio Interface to Initiating state (in the case it were in Stand by state), and the User Equipment Radio Management unit orders to the User Equipment Mobile Interface unit to communicate to the Radio Access Node Radio Management unit to switch its Detection Radio Interface to Advertising state (in the case it were in Stand by state). This is done in order to allow the establishment of the short range communications link supported by the Detection Radio Interface between the Radio Access Node and the User Equipment, once the Radio Access Node and the User Equipment are close enough to each other.

If advertising packets are detected at the User Equipment, the User Equipment checks if the Radio Access Node DRI-ID of the advertising Detection Radio Interface is included in its list of authorized Radio Access Nodes. If it is in the list, both the User Equipment and the Radio Access Node Detection Radio Interfaces will change to the Connect status. Once the connection of the short range radio link between the User Equipment and the Radio Access Node Detection Interface units has been established, the Radio Access Node will switch on the radio section of its femtonode functionality and any other radio section included within the Radio Access Node.

Before switching on the radio section of its femtonode functionality, the Radio Access Node has to check the validity of the previous radio physical channel radiated, which has been selected after scanning radio environment, and therefore, discarding any radio physical channel which is being used in order to avoid interference. This autoconfiguration procedure is carried out whenever the femtonode functionality is switched on.

When the radio section of the femtonode functionality is switched on, the User Equipment Mobile Interface unit will try to camp in the femtonode cell. Both the Radio Access Node and the User Equipment will wait for a predetermined time (Camping Check Time) to check if the User Equipment has camped in the femtonode cell.

If the User Equipment has camped in the femtonode cell after the Camping Check Time has elapsed, both the Radio Access Node and the User Equipment Detection Radio Interfaces will be switched to the Stand by state. In the stand by state, the Detection Radio Interface does not either transmit or check the reception of any radio packet. The rationale for switching to the Stand by state is twofold; saving battery energy resources in the User Equipment, and reducing the radio spectrum occupation and the level of interference produced by the Detection Radio Interface.

Once the Camping Check Time has elapsed, if the User Equipment has not camped in the femtonode cell, the User Equipment Detection Radio Interface will check if the Detection Radio Interface is still in Connect state with the Radio Access Node. If the answer is yes, the femtonode radio section and other radio interfaces in the Radio Access Node will remain in on state, but if the answer is no the User Equipment Detection Radio Interface switch to the Initiating state, and the Radio Access Node Detection Radio Interface will switch to the Advertising state, and the radio section of the femtonode functionality and any other radio section of the Radio Access Node will be switched off.

The femtonode functionality radio transmitter section remains switched off until the next time the User Equipment and Radio Access Node Detection Radio Interfaces change again to the Connect status. However, if the femtonode functionality radio receiver section is used to perform the macrocell detection to update the Femto Overlapping Macrocells list, it must be periodically switched on. In fact, the list could be updated immediately after switching off the radio transmitter section and before switching off the radio receiver section in order to minimize the number of macrocell detection procedures carried out when the femtonode functionality transmitter radio section is on.

### NFC RFID Based Femtonode and Other Radio Sections Switching Procedure

In another embodiment of this invention, illustrated by FIG. 11, the switching on and off procedure of the radio section of the femtonode functionality and any other radio sections of the Radio Access Node relies in a direct communication between the Radio Access Node and the User Equipment, based on a Detection Radio Interface supported by passive Near Field Communications Radio Frequency Identification (NFC-RFID) and detects also when the User Equipment Mobile Interface camps in the Radio Access Node femtonode functionality to switch the User Equipment and the Radio Access Node Detection Radio Interfaces to Stand by state.

This embodiment of the invention makes use of short-range 13.56 MHz Passive Near Field Communications Radio Frequency Identification (NFC-RFID) via magnetic field induction. This embodiment of the invention makes use of the Passive Communication Mode of NFC-RFID as described in the standard “ECMA-340 Near Field Communication Interface and Protocol” [13], where an Initiator device is included in the Radio Access Node and a Target device is included in the User Equipment. The Initiator provides a carrier field and the Target device answers by modulating existing field. In this mode, the Target device draws its operating power from the Initiator-provided electromagnetic field, and thus does not draw any power from the User Equipment battery.

In this embodiment of the invention, The User Equipment Detection Radio Interface is based in a passive mode NFC-RFID Target device (ECMA-340, 4.23 Target) in the Sense state (ECMA-340, 11.2.1.9 SENSE State), that can be identified by means of its NFC Identifier (NFCIDn) (ECMA-340, 4.16 NFC Identifier). On the other hand, the Radio Access Node Detection Radio Interface is based in a NFC-RFID Initiator device (ECMA-340, 4.7 Initiator) that can be identified by means of its NFC Identifier (NFCIDn).

ECMA-340 transport protocol (ECMA-340 12 Transport Protocol) is handled in three parts: i) activation of the protocol, which includes the Request for Attributes and the Parameter Selection, ii) the data exchange protocol, iii) the deactivation of the protocol including the Deselect and the Release. This invention is not restricted to any specific Transport Protocol procedure between those specified in ECMA-340, provided that as a result of the information exchange between the Initiator and the Target, the Initiator retrieves the NFC Identifier of the Target included in the User Equipment.

In this embodiment of the invention, the user will bring the User Equipment within a few centimetres of the Radio Access Node, in order to allow the Initiator to detect the target, and then the femtonode radio section will be switched on. As indicated above, the state diagram of the NFC RFID based femtonode and other radio sections switching procedure is depicted in FIG. 11.

As it is depicted in FIG. 11, the switching procedure is as follows. When the User Equipment is turned on, the Radio Access Node femtonode functionality radio section or any other radio section will be in their default off state.

When the Radio Access Node NFC Initiator detects the User Equipment Target, it retrieves its NFCIDn. Then, the Radio Access Node Radio management unit, checks if the NFCIDn is included in its Accessible User Equipments list. If it is in the list, the Radio Access Node will switch on the radio section of its femtonode functionality or any other radio section.

Before switching on the radio section of its femtonode functionality, the Radio Access Node has to check the validity of the previous radio physical channel radiated, which has been selected after scanning radio environment, and therefore, discarding any radio physical channel which is being used in order to avoid interference. This autoconfiguration procedure is carried out whenever the femtonode functionality is switched on.

Any other radio section that needs to check the radio environment to select its physical radio channel before starting radiating will do similarly.

When the radio section of the femtonode functionality is switched on, the User Equipment Mobile Interface unit will try to camp in the femtonode cell. The Radio Access Node will wait for a predetermined time (Camping Check Time) to check if the User Equipment has camped in the femtonode cell.

When the User Equipment tries to camp on a femtocell with a Location Update message, it is required to send the IMSI which identifies the subscriber in order to validate the access rights. If the IMSI is included in the Accessible User Equipments list, the Location Update message will be progressed to the core network, and the User Equipment will camp on the femtocell. On the contrary, if the IMSI is not in the Access Control List, the femtonode will reject the location updating procedure with a Location Update Reject message.

If the User Equipment has camped in the femtonode cell after the Camping Check Time has elapsed, the femtonode functionality radio section or any other radio section will remain in the on state. If the User Equipment has not camped in the femtonode cell, or leaves the femtonode cell once it has previously camped in it, the Radio Access Node will switch off the femtonode functionality of the Radio Access Node and any other radio functionality included in it.

The femtonode functionality radio transmitter section remains switched off until the next time the User Equipment and Radio Access Node Detection Radio Interfaces change again to the Connect status. However, the femtonode functionality radio receiver section may be switched on periodically to perform the macrocell detection and therefore update the Femto Overlapping Macrocells list. In fact, it could be updated immediately after switching off the radio transmitter section and before switching off the radio receiver section in order to minimize the number of macrocell detection procedures carried out when the femtonode functionality transmitter radio section is on.

Regarding the Accessible User Equipments list, it is a list that is stored in the Radio Management unit of the Radio Access Node, and includes the IMSI numbers and the NFCIDn numbers of the NFC targets of the User Equipments that are authorized to connect to the Radio Access Node.

Other Actions on the Customer's Premises Equipment In another embodiment of this invention, all the procedures that have been described so far to switch on or off the femtonode functionality radio section, or any other radio section of the Radio Access Node, can be applied to perform any other action on the Radio Access Node or on any other equipment that could be connected to the Radio Access Node. Some examples of this embodiment, but not precluding any other implementation, are i) switching on or off some internal functionalities of the Radio Access Node, like an internal router, ii) perform actions on equipment connected to the Radio Access Node, like activating an alarm system or controlling lights, heating, etc.

### Advantages of the Invention

The main advantage of this invention, as it has been described in this specification, is switching off any unnecessary radio emissions of a femtonode, or any other indoor radio interface, when the user is not very close to the femtonode. In this way, the average level of interference in a multi-dwelling building or office can be statistically reduced, as in many occasions many femtonodes will be not radiating, and then the active femtonodes and the layer of macronodes will suffer a lower interference, giving them the possibility to provide a higher throughput to the customers. On the other hand, when the femtonode or any other radio section is radiating when the customer is not nearby also results in an unnecessary power consumption, which can be reduced if this invention's switching off procedure is implemented.

As an example, some simulations have been done to analyze the average throughput that an LTE femtonode can provide in a single apartment, with no interference or with interference from neighbouring apartments. The results have shown a throughput better than 24 Mbps in all the apartment area when no interference is present (femtonode in the centre of the apartment, 20 MHz bandwidth, 15 dBm power), and a throughput worse than 1 Mbps in some apartment's area when the interference of another femtonode is present (femtonodes at every other side of the dividing wall between apartments, 20 MHz bandwidth, 15 dBm power).

Some implementations have been proposed for switching off the radio section of a femtonode when the user is not in the neighbourhood of his/her femtonode [6] [7]; these solutions detect when the user Equipment is camped in the nearest macro cell to the femtonode, in order to decide when switching on or off the femtonode. These implementations are of little value when the User Equipment is usually camped in the predefined macrocell, something very usual in suburban and rural macrocells that provide a wide coverage, or that can happen in dense urban areas depending on the customer habits or usage scenario.

The advantage of this invention over other existing solutions is that it switches on the femtonode, or any radio interface that could be supported by a Radio Access Node, only when the user is within his/her premises (home, office), thanks to the help of a short range radio interface between the femtonode and the user terminal.

A person skilled in the art could introduce changes and modifications in the embodiments described without departing from the scope of the invention as it is defined in the attached claims.

### ACRONYMS AND ABBREVIATIONS

ADSL Asymmetric Digital Subscriber Line
CGI Cell Global Identification
CI Cell Identity
DRI Detection Radio Interface
DRI-ID Detection Radio Interface Identification number
DSLAM Digital Subscriber Line Access Multiplexer
FTTH Fibre to the Home
GSM Groupe Special Mobile
HSPA High Speed Packet Access
IMSI International Mobile Subscriber Identities
IP Internet Protocol
LAC Location Area Code
LTE Long Term Evolution
MCC Mobile Country Code
MNC Mobile Network Code
NFCIDn Near Field Communications Identification number
NFC-RFID Near Field Communications Radio Frequency Identification
ONT Optical Network Terminator
PLC Power Line Communications
PLMN Public Land Mobile Network
RAN Radio Access Node
RNC Radio Network Controller
SMS Short Message Service
SMSC Short Message Service Center
SMS-GMSC Short Message Service Gateway MSC
UE User Equipment
UMTS Universal Mobile Telecommunication System
U-MSC UMTS Mobile Switching Center
UTP Unshielded Twisted Pair
UWB Ultra Wideband
WiFi Wireless Fidelity

### REFERENCES

[1] IEEE 802.3 “Carrier sense multiple access with Collision Detection (CSMA/CD) Access Method and Physical Layer Specifications”.
[2] IEEE 802.11 “Wireless LAN Medium Access Control (MAC) and Physical Layer (PHY) Specifications.
[3] ITU-T G.984.1 “Gigabit-capable passive optical networks (GPON): general characteristics”.
[4] 3GPP TS 25.467 “UTRAN architecture for 3G Home Node B (HNB); Stage 2”.
[5] 3GPP TS 36.133 “Requirements for support of radio resource management”.
[6] Patent application US 2009/0285143 A1 Nov. 19, 2009, “Apparatus and method for saving power of femto base station in wireless communication system”.
[7] Patent application US 2010/0002614 A1 Jan. 7, 2010 “Low power modes for femto cells”.
[8] Patent application WO 2010/052112 “Reducing interference and energy consumption for femto base stations”.
[9] Patent application WO 2010/027569A1 “Presence-aware cellular communication system and method”.
[10] Patent application EP 2056628A1 “Communication network element and method of switching activity states”.
[11] EP 2157824A1 “Network node, network and a method for waking up a network node”.
[12] 3GPP R3-080658 “Dynamic Setup of HNBs for Energy Savings and Interference Reduction”. TSG RAN WG3 Meeting #59bis, Shenzhen, China, 31 Mar.-3 Apr. 2008.
[13] ECMA-340 Near Field Communication Interface and Protocol.

1. Method for the reduction of energy consumption and radio interference in a radio access node, comprising switching on or switching off at least part of said radio access node as a function of, respectively, the reception by said radio access node, of a radio signal transmitted by a wireless portable processing device, or the absence of such a reception, wherein said method is characterised in that said radio signal is a low-power radio signal transmitted by a low-power radio interface of said wireless portable processing device.

2. Method as per claim 1, wherein said at least part of said radio access node to switch on or off comprises at least one femtonode functionality radio section and/or at least one other radio section.

3. Method as per claim 2, wherein said at least part of said radio access node to switch on or off comprises also other functional units.

4. Method as per any of the previous claims, where said reception of said low-power radio signal by said radio access node is performed by means of a detection radio interface, said wireless portable processing device also comprising a detection radio interface, the method comprising using said detection radio interfaces to establish a short range radio link there between, said low-power radio signal being responsible, at least in part, for said short range radio link establishment.

5. Method as per claim 4, wherein said switching on or switching off at least part of said radio access node is also carried out as a function of, respectively, detecting the establishment/presence or breaking/absence of said short range radio link.

6. Method as per any of the previous claims, wherein said low-power radio interface is one of a low energy Bluetooth interface, a low power Ultra Wideband interface and a low power Zigbee interface.

7. Method as per claim 6 when depending on claim 5, wherein said detection radio interfaces are one of Basic Rate/Enhanced Data Rate Bluetooth IEEE 802.15.1 radio interfaces, Bluetooth Low Energy IEEE 802.15.1 radio interfaces, Bluetooth Low Energy IEEE 802.15.1 radio interfaces that make use of the proximity profile for mobile phones in order to perform automatic actions, Ultra-Wideband IEEE 802.15.4a radio interfaces, Zigbee PRO Feature Sets, other solution based on IEEE 802.15.4-2006 radio interfaces and other short range radio interfaces.

8. Method as per claim 5, comprising carrying out said switching on by performing the next steps:
setting a detection radio interface of the radio access node to a default Advertising state, where advertising packets are emitted, while its femtonode functionality radio section and/or any other radio section is in its default off state;
setting the detection radio interface of the wireless portable processing device to an Initiating default state at which the wireless portable processing device is searching for advertising radio packets emitted from any radio access node detection radio interface included in an accessible radio access nodes list; and:
if as a result of said searching advertising packets are detected at the wireless portable processing device, checking, by the latter, if the radio access node detection radio interface identification, or DRI-ID, included in the detected advertising packets is included in its accessible radio access nodes list, and if so changing the detection radio interfaces of both the wireless portable processing device and the radio access node to a Connect status where said short range radio link is established.

9. Method as per claim 8, wherein if the detection radio interfaces of the wireless portable processing device and the radio access node lose the Connect state, said short range radio link being broken, the method comprises making them to return to their respective Initiating and Advertising status, and the Radio Access Node femtonode functionality radio section and/or any other radio section switches off.

10. Method as per claim 8, wherein if as a result of said searching for advertising radio packets the wireless portable processing device detection radio interface does not detect any advertising packet from some radio access node included in said accessible radio access nodes list, the method comprises keeping it in the Initiating state.

11. Method as per claim 8, wherein if as a result of said searching for advertising radio packets the wireless portable processing device detection radio interface does not detect any advertising packet from some radio access node included in said accessible radio access nodes list, the method comprises checking, for a predetermined time, by means of the wireless portable processing device, if the wireless portable processing device is camping in some of the macrocells included in a Femto Overlapping Macrocells list, and:
if it is not camping in any of said macrocells, the method comprises determining by the wireless portable processing device that the latter is not either in the neighbourhood of its femtonode or camped in it, then switching its detection radio interface to Stand by status and communicating with the radio access node to make it switch its detection radio interface to Stand by status;
if it is camping in any of said macrocells, the method comprises determining by the wireless portable processing device that the latter is in the neighbourhood of its femtonode but not camped in it, then switching its detection radio interface to Initiating state and communicating with the radio access node to make it switch its detection radio interface to Advertising state;

12. Method as per any of the previous claims, comprising updating a Femto Overlapping Macrocells list stored at said radio access node immediately after switching off its femtonode radio transmitter section and before switching off its femtonode radio receiver section.

13. Method as per claim 10, 11 or 12, comprising, once said short range radio link has been established and the femtonode functionality radio section and/or any other radio section is switched on, checking, for a predetermined time, by means of the wireless portable processing device and the radio access node, if the wireless portable processing device is camping in the radio access node femtonode functionality, and if so switching the detection radio interfaces of the wireless portable processing device and the radio access node to a Stand by state.

14. Method as per claim 13 when depending on claim 11, wherein if after lapsing said predetermined time said wireless portable processing device is not camping in the radio access node femtonode functionality, the method comprises switching the detection radio interface of the wireless portable processing device to its Initiating state, the detection radio interface of the radio access node to its Advertising state, and switching off the femtonode functionality radio section and/or any other radio section.

15. Method as per claim 13 when depending on claim 12, wherein if after lapsing said predetermined time said wireless portable processing device is not camping in the radio access node femtonode functionality, the method comprises checking if the detection radio interface of at least the wireless portable processing device is in its Connect state, and:
if so, the method comprises keeping the radio access node femtonode functionality radio section and/or any other radio section in its on state; or
if not, the method comprises switching the detection radio interface of the wireless portable processing device to its Initiating state, the detection radio interface of the radio access node to its Advertising state, and switching off the femtonode functionality radio section and/or any other radio section.

16. Method as per claim 11 or 13, wherein at said Stand by state the detection radio interfaces do not either transmit or check the reception of any radio packet.

17. Method as per any of claims 1 to 3, where said reception of said low-power radio signal by said radio access node is performed by means of a detection radio interface supported by passive Near Field Communications Radio Frequency Identification, or NFC-RFID, comprising an Initiator device, and said wireless portable processing device also comprising a detection radio interface unit comprising a NFC-RFID Target device, the method comprising providing by said Initiator device a carrier field and answering thereto, by means of the Target device, by modulating existing field and sending the resulting modulated signal to the Initiator device, said modulated signal being said low-power radio signal.

18. Method as per claim 17, comprising carrying out said switching on by performing the next steps:
detecting by said Initiator device said Target device, a NFC identification, or NFCIDn, being included in said resulting modulated signal; and
checking, the radio access node, if the retrieved NFCIDn is included in an accessible user equipments list, and if so, switching on, by means of the radio access node, its femtonode functionality radio section and/or any other radio section.

19. Method as per claim 18, wherein once the femtonode functionality radio section and/or any other radio section is switched on, the method comprises checking, for a predetermined time, by means of the wireless portable processing device and the radio access node, if the wireless portable processing device is camping in the radio access node femtonode functionality, and:
if so, keeping the femtonode functionality radio section and/or any other radio section in the on state; or
if it is not camping in the femtonode functionality, switching off the femtonode functionality radio section and/or any other radio section.
